(19) United States
(12) Patent Application Publication
(10) Pub. No.: US 2012/0159136 A1
(43) Pub. Date: Jun. 21, 2012

(54) COMPUTER SYSTEM BOOT ENHANCEMENTS WITH USER OVERRIDE

(76) Inventors: Michael A. Rothman, Puyallup, WA (US); Vincent J. Zimmer, Federal Way, WA (US); Robert C. Swanson, Olympia, WA (US); Palsamy Sakthikumar, Puyallup, WA (US); Mallik Bulusu, Olympia, WA (US)

(21) Appl. No.: 12/969,655

(22) Filed: Dec. 16, 2010

(51) Int. Cl. G06F 9/00

(52) U.S. Cl. 713/2

(57) ABSTRACT

Methods, systems and computer program products are disclosed for enhanced system boot processing that is faster to launch the OS because it does not interrogate I/O devices for possible interruption, but that also may be modified to interrogate such devices based on a user selection mechanism. The user selection mechanism may be, for at least one embodiment, a software mechanism such as a control panel module. For other embodiments, the user selection mechanism may be a hardware mechanism, such as a power button or other hardware button or switch. Other embodiments are described and claimed.

### BACKGROUND

Many computing systems have traditionally allowed a user to interrupt the boot process in order to perform various setup functions such as setting the system clock, managing memory settings, configuring a new hard drive, changing the boot order, password reset, etc. The interruption may be initiated by the user's activation of a particular keyboard button(s), such as delete, F1, F2, F10, or ctrl-alt-delete during BIOS (basic input-output service) boot processing. For such systems, the boot time may be significantly lengthened as the I/O devices, such as a USB keyboard, are enumerated and polled to determine if the user has indeed initiated such interruption.

### BRIEF DESCRIPTION OF THE DRAWINGS

FIG. 1 is a flowchart illustrating at least one embodiment of an enhanced boot process with user-selectable interruption feature.

FIG. 2 is a flowchart illustrating at least one embodiment of the method of FIG. 1 wherein the user selection mechanism is implemented in software.

FIG. 3 is a block data and control flow diagram illustrating at least one embodiment of the method of FIG. 1 wherein the user selection mechanism is implemented in hardware.

FIG. 4 is a flowchart diagram illustrating overhead associated with enumeration and interrogation of I/O devices during pre-OS boot processing.

FIG. 5 is a block diagram illustrated first and second systems in accordance with at least one embodiment of the present invention.

FIG. 6 is a block diagram of a system in accordance with at least one other embodiment of the present invention.

FIG. 7 is a block diagram of a system in accordance with at least one other embodiment of the present invention.

### DETAILED DESCRIPTION

Embodiments provide user-selectable interruption of pre-OS boot processing for a computing system. More specifically, a default state of a computing platform provides enhanced boot processing that is not user-interruptable. The enhanced nature of such processing is that it does not poll I/O (input/output) devices and therefore is able to boot the operating in a shorter amount of time. Enhancement thus lies in, at least in part, in faster booting of the operating system. However, a user may select to allow interruption of the boot processing and, if so, I/O devices are polled in order to determine if a user-initiated interrupt of boot processing should be processed. Interrupt of pre-OS boot processing may be desired, for example, if the user wishes to enter BIOS setup information or view diagnostics. The mechanism by which a user may enable boot interruption may be of various embodiments. Described herein are just two examples of the many possible embodiments of such selection mechanism. A software-based user selection mechanism includes processing of the BIOS and an operating system, as well as user input into a user-level software module, such as driver or applet. Another embodiment employs a hardware selection mechanism, which overlays existing hardware (such as a power button) with additional functionality to allow user selection of boot interruption. Such hardware embodiment may include the BIOS and chipset of a computing platform.

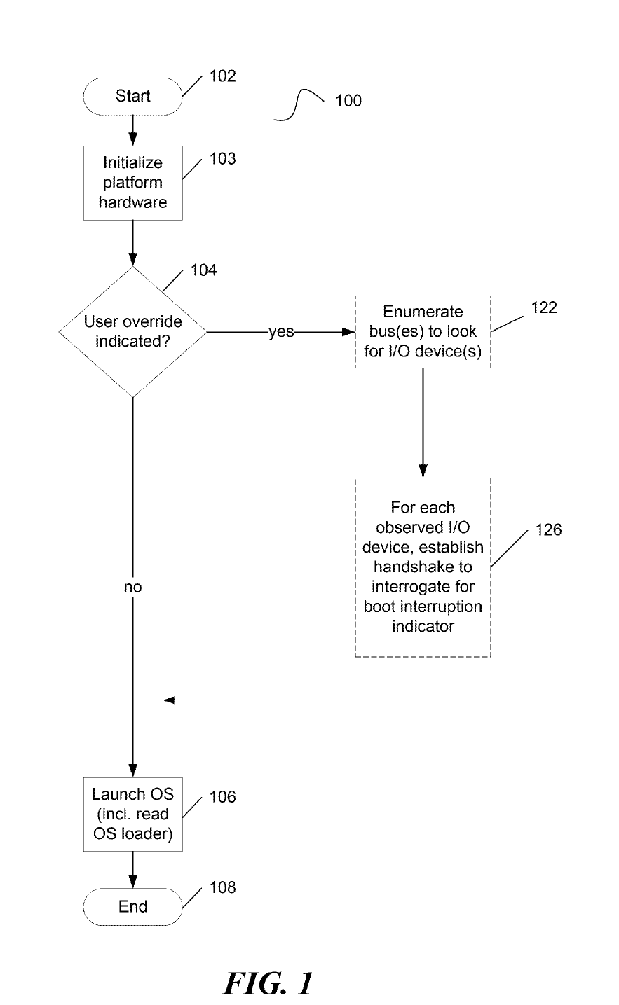

Referring now to FIG. 1, shown is a general method 100 to perform enhanced boot processing that involves a shorter boot time than a boot process that permits user interruption. The method 100 also provides a user-selectable override option to perform I/O device polling/interrogation to allow the boot process to be interrupted by the user.

FIG. 1 illustrates that the method 100 begins at block 102 and proceeds to block 103. At block 103, platform hardware, such as the CPU and chipset, are initialized.

From block 103, processing proceeds to block 104. At block 104, it is determined whether the user has selected to override the enhanced, faster boot option. If so, processing proceeds to block 122 and the following block 124, where input/output (I/O) devices such as keyboard(s) and mouse(s) are identified and queried to determine if a user input has been received. The user input may, for example, be depression of a “hot key” or other I/O indication that the user wishes to interrupt the boot processing. For at least some embodiments the I/O device may be a keyboard. For other embodiments, the I/O device may be a mouse, a numeric keypad, a touchscreen, a virtual keyboard displayed on a display screen, or the like.

If it is determined at block 104 that the user has not selected to override the enhanced boot processing, then processing proceeds to block 106. At block 106, the boot loader is read and the OS is launched. That is, at block 106 the BIOS causes the operating system to begin execution. Processing then ends at block 108. For at least one embodiment, such boot processing is “enhanced” in the sense that the boot proceeds more quickly because the operations at blocks 122 and 124 are not performed, saving time during the boot process. That is, the operating system is booted more quickly for the enhanced boot process that performs blocks 103 and 106, but does not perform blocks 122 and 124.

If, however, it is determined at block 104 that the user has selected to override the enhanced boot option, and instead wishes for the next boot process to be interruptable, then the processing at block 122 is performed. At block 122, one or more bus on the platform is enumerated to look for I/O devices. Since there is no direct method for the BIOS or OS to determine which slots have devices installed (nor the functions the device implements) the bus(es) are enumerated at block 122 to look for user input I/O devices, such as a keyboard and/or mouse. Such bus may be a USB bus, PCI bus, PCI-express bus, PS/2 bus, or any other bus over which I/O devices may communicate. In other embodiments, the devices may be identified over a point-to-point link rather than a bus.

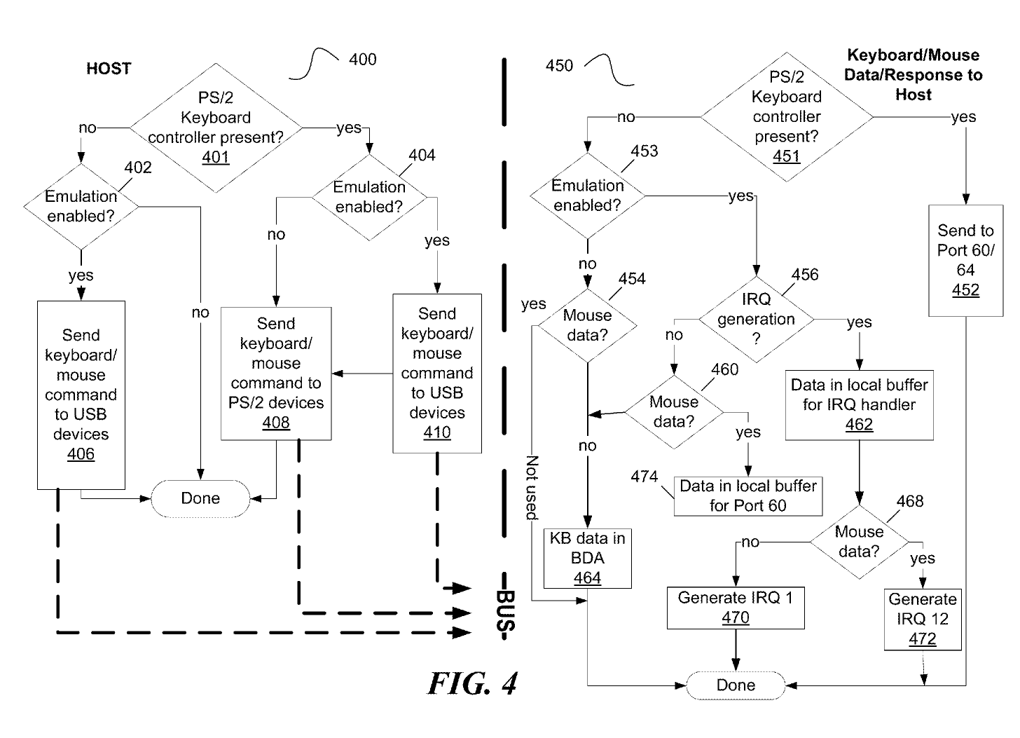

From block 122, processing proceeds to block 124. At block 126, the I/O device(s), if any, that were identified at block 122 are interrogated to determine whether the user has provided an input to indicate that the boot process is to be interrupted. They are thus monitored for user-initiated input. For at least one embodiment, the interrogation involves establishing a handshake with the device and polling the device. Establishing the handshake may involve, for example, sending data of a particular format to a particular port. An example of handshaking and polling activity that may be performed at block 126 is illustrated in FIG. 4.

Turning briefly to FIG. 4, shown is a method 400 for transmitting handshake information from the host device (such as the CPU of the platform) to an I/O device. Also shown is a method 450 for transmitting data from an I/O device to the host.

FIG. 4 illustrates that a host device sends commands to the keyboard and/or mouse according to method 400. At least some embodiments of the method 400 support a BIOS feature that allows a user to enable emulation of I/O ports 64h and 60h so that there is full PS/2 legacy support for USB keyboards and mice. If the CPU writes to port 0x64, the byte is interpreted as a command byte. If the CPU writes to port 0x60, the byte is interpreted as a data byte. The method 400 determines whether PS/2 keyboard device is present at block 401. If a PS/2 device is detected (401) and emulation is enabled for USB devices as well (404), communication commands are sent to both USB devices (410) and PS/2 devices (408). If no PS/2 keyboard controller is present (401) and emulation is not enabled (402), then no keyboard commands are sent. If there is no PS/2 keyboard controller present (401), but PS/2 functionality is to be emulated for USB devices (402), then commands are sent to USB devices at block (406).

FIG. 4 illustrates that I/O devices, such as keyboard and mouse devices, may also perform 450 time-consuming communications processing responsive to the host during pre-OS boot processing. If a PS/2 keyboard is present (451), the keyboard sends (452) any response to ports 0x60 and/or 0x64, the PS/2 I/O ports. Otherwise, (e.g., if a USB keyboard is present), communication processing proceeds differently for, depending on whether emulation is enabled. FIG. 450 illustrates that the USB keyboard may put data 462 in a local buffer for a handler for IRQs (Interrupt ReQuests) and may generate 470 an IRQ to interrupt the host if emulation is enabled. A mouse may similarly store data in the local IRQ handler buffer at block 462 and generate IRQ 12 at block 472. Alternatively, the mouse may send (460, 474) data to port 60h if PS/2 emulation is enabled for the mouse and an IRQ is not generated. Otherwise, if emulation is not enabled the USB keyboard may send (454, 464) communication information to the Bios Data Area, as may the mouse (460, 464).

Returning to FIG. 1, one can see that all the processing of methods 450 and 455 of FIG. 4 may be skipped if user override is indicated at block 104. Otherwise, processing proceeds according to embodiments of methods 400 and 450 shown in FIG. 4. Such processing 126 may also include enabling of System Management Mode (SMM) interrupts to perform emulation of PS/2 mouse and/or keyboard functionality for USB devices.

From block 126, processing proceeds to block 106, where the OS is launched as described above. Processing then ends at block 108.

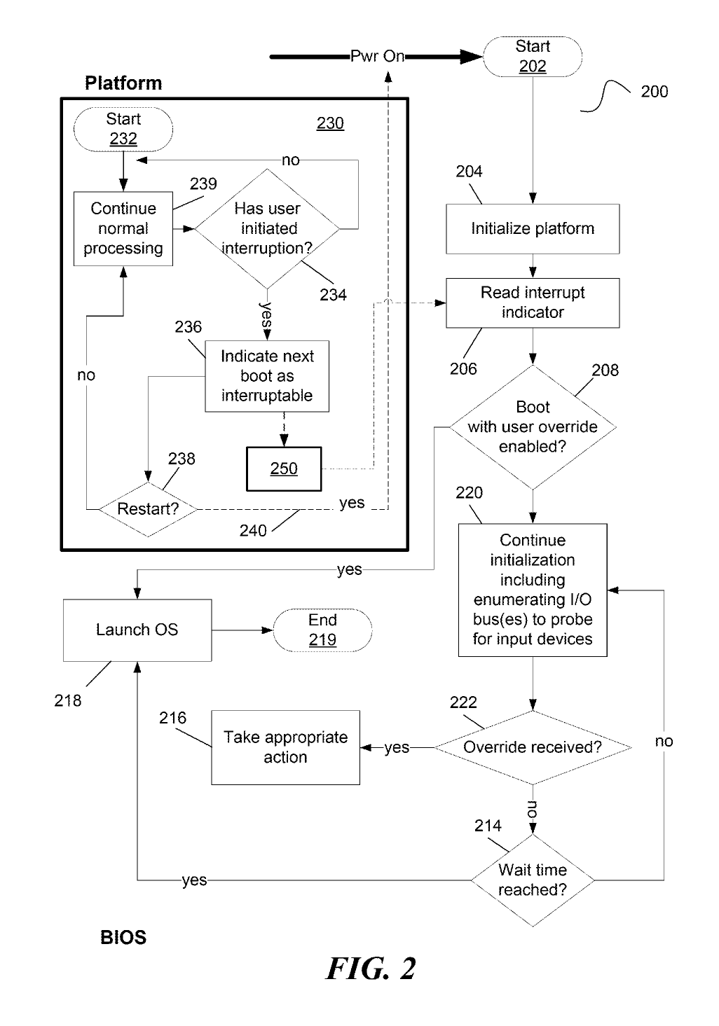

FIG. 2 is a flowchart illustrating at least one embodiment 200 of a method, such as the method 100 shown in FIG. 1, which utilizes a software input mechanism to capture (in a mailbox storage mechanism) a user's desire to render the next boot interruptable across the next platform reset. FIG. 2 illustrates that the processing involves the interaction of processing 230 that occurs during OS runtime as well as processing (202, 204, 206, 208, 220, 222, 214, 216, 218, 219) that occurs in pre-OS boot processing (such as BIOS pre-boot processing). FIG. 2 illustrates that the OS runtime processing 230 starts at block 232 and proceeds to block 239, where normal runtime OS processing occurs.

For at least one embodiment of the method 200 shown in FIG. 2, the user's desire to initiate boot interruption capability is determined at block 234. For such embodiment, the user may have entered input via a software input mechanism. Such input mechanism, for example, may be a platform-specific, OS-specific software module executed during OS runtime. For at least one embodiment, the software module utilized by the user to initiate boot interruption capability is a control panel program. One such embodiment may include an applet of the control panel program that allows the user to set one or more firmware environment variables (such as, e.g., a Unified Extensible Firmware Interface (UEFI) variable). For other embodiments, the user input may be entered via a driver, applet or other software program separate from the operating system. For any such embodiments, the user's initiation of boot interrupt capability is determined at block 234. For example, for at least one embodiment the determination at block 234 evaluates to “true” if a user has clicked on or otherwise selected a BIOS setup control panel applet and/or an applet to set a variable (such as a UEFI variable). If the evaluation at block 234 evaluates to true, processing proceeds to block 236. Otherwise, normal processing continues at block 239.

At block 236, a value in a storage location accessible to the BIOS is updated. For example, the processing at block 236 may cause an indicator (such as a flag in storage location 250) to be set in the OS present environment, the indicator being visible to the BIOS. Having a memory location 250 accessible to both the operating system and the BIOS is sometimes referred to herein as a mailbox mechanism. The storage location 250 may be any such shared memory location, in either volatile or non-volatile memory (NVM). For at least one embodiment, the storage location 250 is a UEFI variable that is backed up by flash NVM. As will be explained below, on the next boot the BIOS will query the state of such indicator 250, and is thus notified that the user wishes to have the option to interrupt the boot process. Such setting 236 of a value in the shared mailbox location 250, along with the subsequent reading 206 of the value in the mailbox location 250, is referred to herein as a “handshake”.

From block 236, processing proceeds to block 238. At block 238, it is determined whether a reset should be initiated. If not, normal OS runtime processing continues at block 239. Otherwise, a platform reset is initiated via path 240. Whether or not to restart the platform after setting the indicator may be determined based on policy considerations of the particular platform.

FIG. 2 also illustrates the BIOS-side processing (202, 204, 206, 208, 220, 222, 214, 216, 218, 219) related to the handshake. FIG. 2 illustrates that such processing begins at block 202 and proceeds to block 204. At block 204, normal BIOS initialization of the computing platform is performed, along the lines of processing 103 described above in connection with FIG. 1. From block 204, processing proceeds to block 206, where the BIOS side of the handshake is performed.

FIG. 2 illustrates that at block 206 the value in the mailbox 250 is evaluated. If it is determined at block 208 that the value in the mailbox 250 indicates that the current boot should be interrupted, processing proceeds to block 220. Otherwise, processing proceeds to block 218.

At block 220, the user has indicated that the boot should be interruptable. Accordingly, block 220 processing is performed to enumerate and interrogate I/O devices in order to determine whether the user has, indeed, exercised the option to interrupt the boot process. For example, for at least one embodiment, the user may push the F2 key on the keyboard in order to interrupt boot processing to view a diagnostics screen. Or, the user may push a “delete” key or F1 on the keyboard in order to bring up a BIOS setup display panel. One of skill in the art will recognize that many other keystrokes, used alone or in combination, may be detected at block 220. For at least one embodiment, block 220 processing proceeds according to all or some of the processing described above in connection with blocks 122 and 126 of FIG. 1. Also see methods 400 and 450 of FIG. 4.

From block 220, processing proceeds to block 222. At block 222 it is determined whether an interrupt indication has been received at block 220. If so, proceeds to block 216. Otherwise, processing proceeds to block 214.

At block 214, it is determined whether interrogation of I/O devices should continue. If a predetermined amount of time has passed, and no interrupt indication has been received, then processing proceeds to block 218. If, instead, the predetermined amount of time has not yet expired, process proceeds to block 220 in order to monitor or query for an interrupt indication from the user. The predetermined amount of time may vary by platform, and may be based on, at least in part, a platform-specific maximum amount of time permitted to elapse for boot processing before the OS is launched.

At block 216, the user has not only indicated that the boot should be interruptable, but has indeed entered an input that has caused interruption. At block 216, the interruption action is taken. For at least one embodiment, the action taken at block 216 is to display a diagnostics screen. For at least one other embodiment, that action taken at block 216 is to display a BIOS setup user interface menu on a display screen. Such menu may include, for example, one or more of the following options: configure hardware, set the system clock, and/or set various password prompts, such as a password for securing access to the BIOS UI functions itself and preventing malicious users from booting the system from unauthorized peripheral devices. Many other embodiments of block 216 are encompassed by the appended claims.

At block 218, either a) the user has not indicated that the boot should be interruptable (path to block 218 from block 208), or the user has done so, but has not actually exercised the option to interrupt the current boot process (path to block 218 from block 214). In either case, at block 218 the operating system is launched. This processing is similar to the processing of block 106 described above in connection with FIG. 1. For such processing 218, the boot loader is read and the operating system is launched. For the embodiments described herein, the operating system may be any operating system, including any operating system for a desktop personal computing device, laptop, notebook, net book, cell phone, smart phone, tablet, or graphics processing unit, to name a few. From block 218, processing ends at block 219.

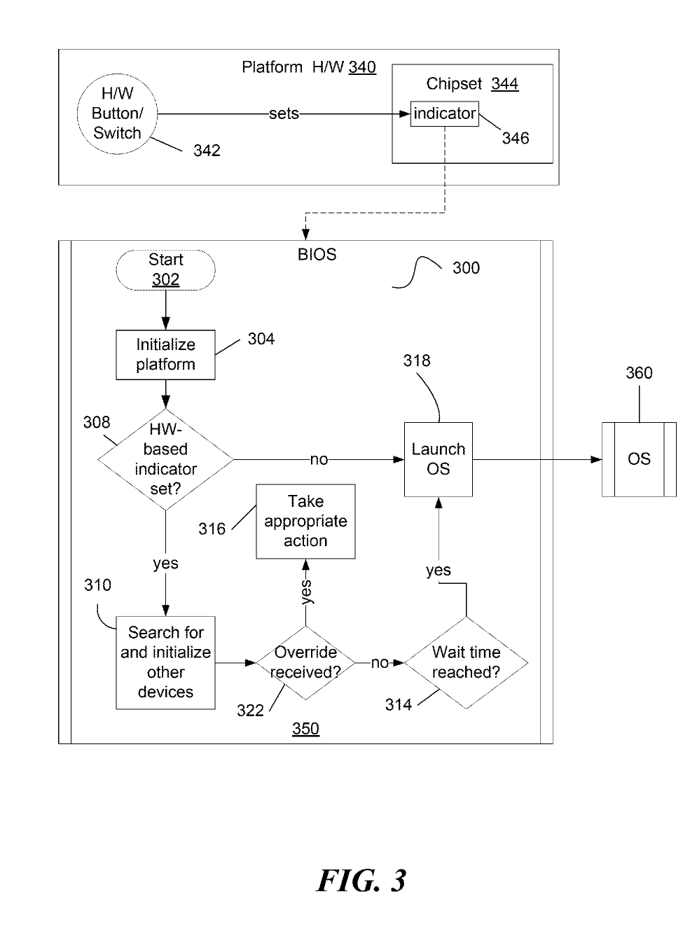

FIG. 3 is a block data flow diagram and flowchart illustrating an embodiment of a method 300 that utilizes a hardware input mechanism to detect user override of enhanced default boot processing. FIG. 3 illustrates that the hardware mechanism for user input includes an indicator 342 (e.g., button or switch 342, such as a power button. For an embodiment that uses a power button as the hardware mechanism 342, the button is overlaid with additional functionality to allow user selection of boot interruption. Such overlay is in addition to the normal function of the button 342.

The embodiment illustrated in FIG. 3 includes processing 300 of the BIOS firmware 350, and also includes operation of hardware features of the computing platform 340, such as the hardware button 342 and chipset 344. Because the overlay of additional functionality is incorporated into existing functionality of the hardware button or switch 342, the embodiment illustrated in FIG. 3 utilizes an additional indicator 346 in a register of a chipset or memory controller hub because that is where normal indicator registers for the power button reside. However, additional embodiments may utilize other types of indicators based on the state of the hardware button; such indicators need not necessarily reside in the chipset or memory controller hub 344n nor necessarily need be stored in a register.

For at least one embodiment, user override of default enhanced boot processing is initiated by user action on the hardware button or switch 342. Such button or switch 342 may be any button or switch of the computing platform 340. Example embodiments of hardware indicator 342 include a power button of the computing platform. Other example embodiments include any other button or switch of the platform, such as a ThinkPad button or Windows button on a keyboard, or a particular Function key of a keyboard (e.g., F1, F2, F11, etc).

For an embodiment that utilizes the power button as the boot interruption override indicator 342, additional functionality for such button is overlaid onto existing functionality. It thus uses an existing hardware feature in a new manner. Regarding existing functionality, many computing systems have an existing scheme referred to herein as the 4-second power override. For such scheme, the power button is used to turn off the computing platform when the platform is currently powered on. Such situations may arise, for example, when processing of the computing platform gets hung or locked up (e.g., the mouse cursor on the screen won't move). Thus, depressing the power button for four or more seconds, when the platform is already powered on, causes a physical power cycle of the machine.

For at least one embodiment, the existing four-second power override function for the power button is managed using a status register 346 in the chipset 344. The status register 346 may be referred to as the PMSTS. For illustrative purposes only, a sample definition for the existing functionality for the 4-second power override feature is set forth at bit 11 in Table 1. Table 1 is intended to provide an example of only one possible embodiment, and should not be taken to be limiting with respect to the amended claims.

TABLE 1
PMSTS—Sample POWER MANAGEMENT STATUS REGISTER (IO)

| Bit | |
|---|---|
| Description | Description |
| 15 | Resume Status (RSM_STS)-R/WC. |
| 14:12 | Reserved. |
| 11 | Power Button Override Status (PWRBTNOR_STS)-R/WC. |
| | 1 = Power Button Override has been signaled. 0 = Power Button Override |
| | has not been signaled. This bit is set when Power Button Override has |
| | been enabled and the PWRBTN# signal has been continuously asserted |
| | for greater than 4 seconds. The chipset automatically transitions the |
| | system into the soft off state and clears the PWRBTN_STS bit. This bit is |
| | only set by hardware and can only be reset by writing a 1 to this bit |
| | position. If PWROK is deasserted, the power button override logic will |
| | not function. This logic works only if the power button is activated while |
| | platform power is already on. |
| 10 | RTC Status (RTC_STS)-R/WC. |
| 9 | Reserved. |
| 8 | Power Button Status (PWRBTN_STS)-R/WC |
| 7:6 | Reserved. |
| 5 | Global Status (GBL_STS)-R/WC. |
| 4 | Bus Master Status (BM_STS)-R/WC |
| 3:1 | Reserved. |
| 0 | Timer Overflow Status (TMROF_STS)-R/WC. |

For at least one embodiment of the method 300 illustrated in FIG. 3, a modified functionality for the power button is used to indicate a user's selection to make the next boot sequence user-interruptable. For such embodiment, the override is indicated when the power button is depressed from an initial powered-off state, but remains activated (even after the platform has begun to power up) for a predetermined amount of time. Such prolonged activation from the off to on state allows the platform to detect the state and to set the new status bit in the register 346 to indicate that the user has selected to make the next boot operation interruptable.

For at least one embodiment, the new user boot interrupt override function for the power button is managed using one of the reserved bits for that existing PMSTS status register 346 in the chipset 344. For illustrative purposes only, a sample definition for the boot interrupt override feature is set forth as bit X in Table 2, where bit X is any currently reserved bit. However, Table 2 is intended to provide an example of only one possible embodiment, and should not be taken to be limited with respect to the amended claims. One of skill in the art will recognize that any bit of the PMSTS may be used to provide the new indicator; such a skilled artisan will also recognize that any other register or storage area may be used to maintain the new status bit, and it need not necessarily be maintained in the PMSTS register 346, or in a register at all, or even in the chipset 344.

TABLE 2
PMSTS—Modified POWER MANAGEMENT STATUS REGISTER (IO)

| Bit | |
|---|---|
| Description | Description |
| 15 | Resume Status (RSM_STS)-R/WC. |
| 14:12 | Reserved. |
| X | Power Button Boot Interrupt Status (PWRBTNINT_STS)-R/WC. |
| | 1 = Power Button Boot Interrupt has been signaled. 0 = Power Button Boot |
| | Interrupt has not been signaled. This bit is set when Power Button Boot |
| | Interrupt has been enabled and the PWRBTN# signal has been |
| | continuously asserted for greater than 4 seconds while PWROK is |
| | deasserted. The chipset automatically transitions the system into the soft |
| | off state and clears the PWRBTN_STS bit. This bit is only set by |
| | hardware and can only be reset by writing a 1 to this bit position. If |
| | PWROK is asserted, the power button boot interrupt logic will not |
| | function. This logic works only if the power button is activated while |
| | platform power is off. |
| 11 | Power Button Override Status (PWRBTNOR_STS)-R/WC. |
| | 1 = Power Button Override has been signaled. 0 = Power Button Override |
| | has not been signaled. This bit is set when Power Button Override has |
| | been enabled and the PWRBTN# signal has been continuously asserted |
| | for greater than 4 seconds. The chipset automatically transitions the |
| | system into the soft off state and clears the PWRBTN_STS bit. This bit is |
| | only set by hardware and can only be reset by writing a 1 to this bit |
| | position. If PWROK is deasserted, the power button override logic will |
| | not function. This logic works only if the power button is activated while |
| | platform power is already on. |
| 10 | RTC Status (RTC_STS)-R/WC. |
| 9 | Reserved. |
| 8 | Power Button Status (PWRBTN_STS)-R/WC |
| 7:6 | Reserved. |
| 5 | Global Status (GBL_STS)-R/WC. |
| 4 | Bus Master Status (BM_STS)-R/WC |
| 3:1 | Reserved. |
| 0 | Timer Overflow Status (TMROF_STS)-R/WC. |

FIG. 3 thus illustrates that a status indicator in PMSTS register 346 is set to indicate the user's selection to make the next boot process interruptable, and that such indicator is set upon a user's activation of a power button 342 while power to the platform is off. The activation not only causes the platform 340 to power up, but by holding the button down for four second or more, such activation also causes the indicator to be set to a predetermined value. Responsive to the initiation of the power up, boot processing 300 is performed. For at least one embodiment, the boot processing 300 is performed by BIOS firmware logic.

FIG. 3 illustrates that the boot processing 300 begins at block 302 and proceeds to block 304. At block 304, hardware elements of the platform 340, such as central processing unit and chipset 344, are initialized. Processing then proceeds to block 308. At block 308, it is determined whether the user has indicated that the current power up boot processing should be interruptable by the user. As is discussed above, at least one embodiment of such processing 308 is performed by querying the state of the power button boot interrupt status bit(s) in the status register 346. If the status bit(s) indicate that the user has selected to make the boot interruptable, processing proceeds to block 310. Otherwise, I/O device interrogation is skipped and processing proceeds directly to block 318 where the operating system 360 is launched.

At block 310, I/O device enumeration and interrogation is performed along the lines of that described above in connection with blocks 122 and 126 of FIG. 1 and with block 220 of FIG. 2. From block 310, processing proceeds to block 322. The operation at blocks 322, 314, and 316 is along the lines of that described above in connection with blocks 222, 214 and 216 of FIG. 2.

The figures discussed above illustrate embodiments wherein the default operation is an enhanced, faster boot process that does not interrogate I/O devices unless a user has selected to override the enhanced processing and instead to make the boot interruptable. However, one of skill in the art will recognize that default processing is a matter of policy and can easily be implemented in reverse. Thus, the selection of whether polling of I/O devices should be part of default boot processing is a matter of platform policy, and may vary for different embodiments. For alternative embodiments, the default boot operation is that the interrogation of I/O devices always occurs in order to provide for boot processing interruption, but that the user can elect, instead, to perform the faster, enhanced boot processing (e.g., no polling or interrogation of I/O devices) via user override processing. In such embodiments, the decision boxes 104, 204 and 304 of FIGS. 1, 2, and 3, respectively, instead lead to boot launch if they evaluate to “true”, and lead to I/O interrogation if they evaluate to “false”. That is, user override results in enhanced boot with no I/O interrogation for such alternative embodiments, and default processing includes the I/O interrogation processing.

The preceding discussion illustrates enhanced boot processing that operates more quickly due to expedited I/O processing. That is, if a user override has not been received, boot processing time is shortened by declining to initialize and interrogate I/O devices for a user-generated boot interrupt indicator. For alternative embodiments, other types of boot enhancement are envisioned. For example, for at least one alternative embodiment, if a user override has not been received, boot processing time is shortened by declining to perform PC recovery boot processing. Otherwise, a user may use one or more of the mechanisms described above, or their equivalents, to indicate that boot recovery processing should be performed during the next boot operation.

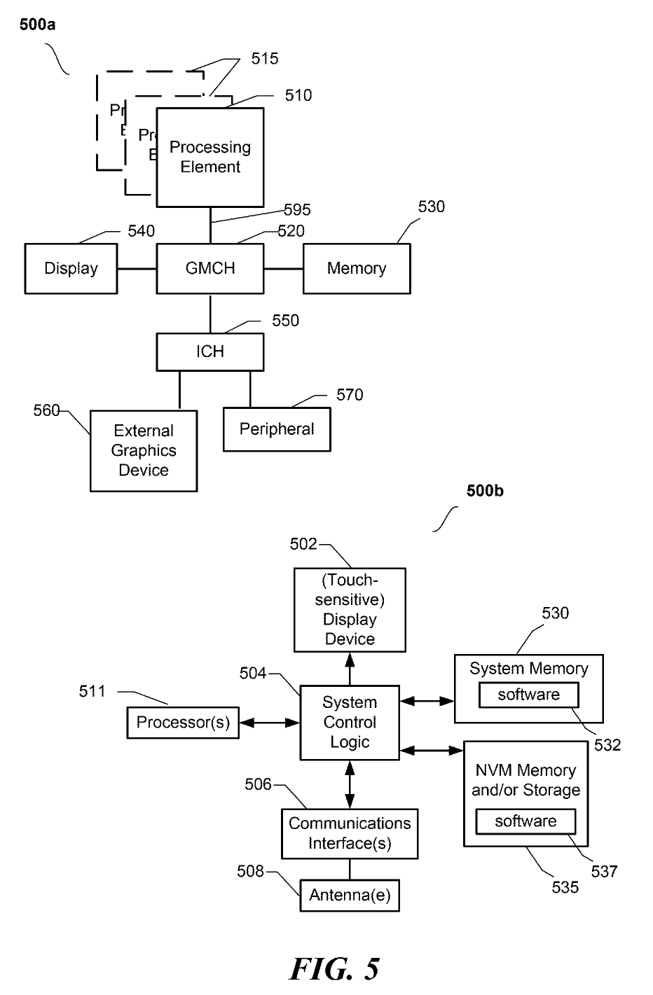

Referring now to FIG. 5, shown are block diagrams of a first system 500a and a second system 500b, each of which may perform embodiments of the user-overridable enhanced boot processing described above. As shown in FIG. 5, the first system 500a may include one or more processing elements 510, 515, which are coupled to graphics memory controller hub (GMCH) 520. The optional nature of additional processing elements 515 is denoted in FIG. 5 with broken lines.

Each processing element 510, 515 may be a single core or may, alternatively, include multiple cores. The processing elements 510, 515 may, optionally, include other on-die elements besides processing cores, such as integrated memory controller and/or integrated I/O control logic. Also, for at least one embodiment of the first system 500a, the core(s) of the processing elements 510, 515 may be multithreaded in that they may include more than one hardware thread context per core.

FIG. 5 illustrates that the GMCH 520 may be coupled to a memory 530 that may be, for example, a dynamic random access memory (DRAM). For at least one embodiment, the memory 530 may include code or instructions that comprise an operating system (e.g., 360 of FIG. 3).

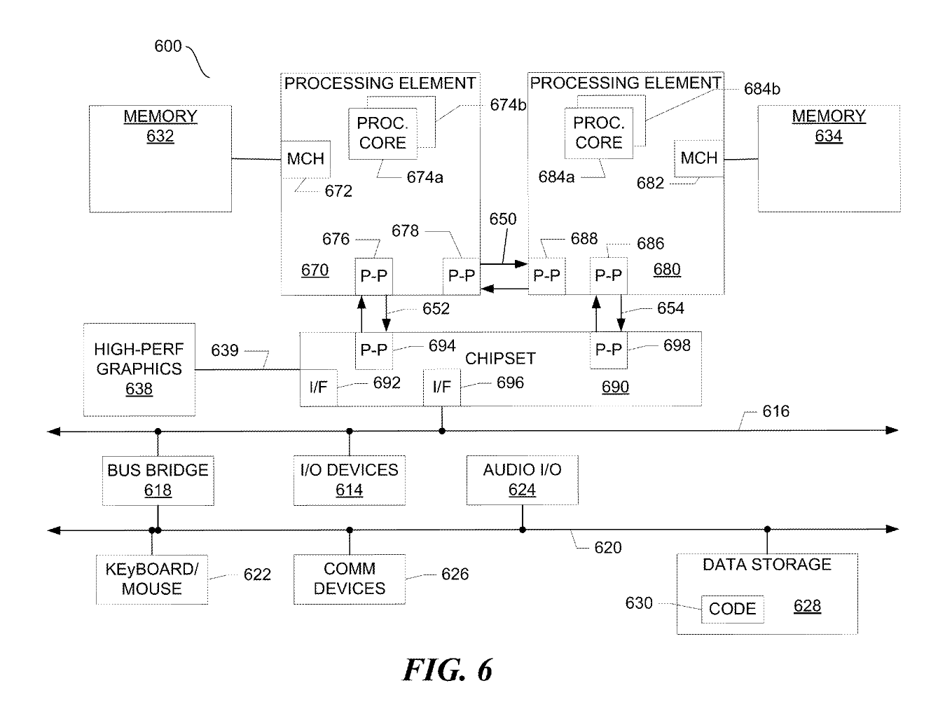

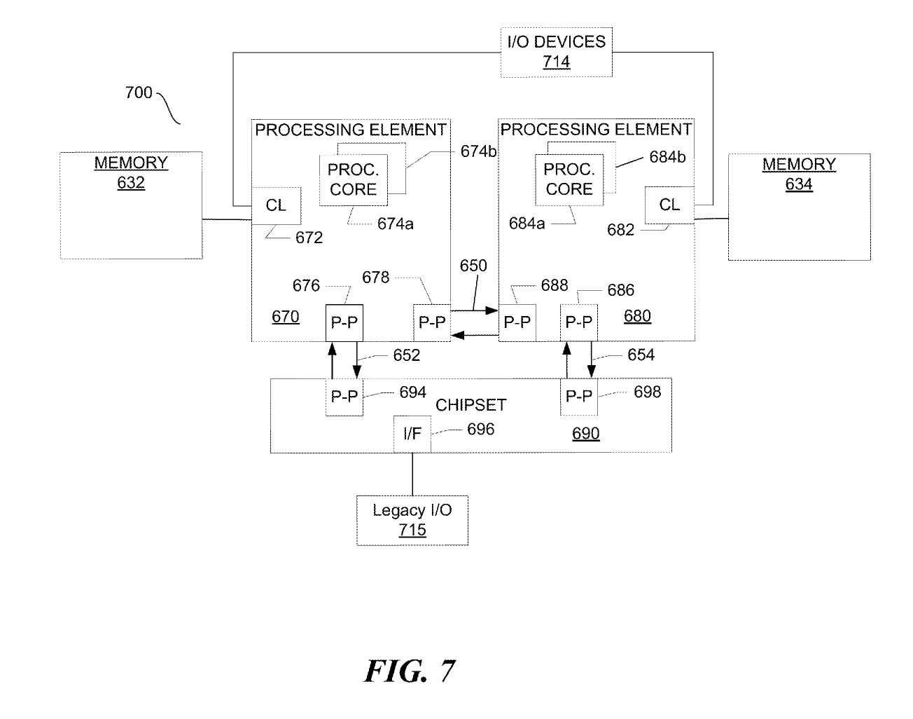

The GMCH 520 may be a chipset, or a portion of a chipset. The GMCH 520 may communicate with the processor(s) 510, 515 and control interaction between the processor(s) 510, 515 and memory 530. The GMCH 520 may also act as an accelerated bus interface between the processor(s) 510, 515 and other elements of the system 500a. For at least one embodiment, the GMCH 520 communicates with the processor(s) 510, 515 via a multi-drop bus, such as a frontside bus (FSB) 595. For other embodiments (see, e.g., FIGS. 6 and 7), the GMCH 520 communicates with the processors(s) 510, 515 via a point-to-point interconnect.

Furthermore, GMCH 520 is coupled to a display 540 (such as, e.g., a flat panel display or touch-sensitive display device). GMCH 520 may include an integrated graphics accelerator. GMCH 520 is further coupled to an input/output (I/O) controller hub (ICH) 550, which may be used to couple various peripheral devices to system 500a. Shown for example in the embodiment of FIG. 5 is an external graphics device 560, which may be a discrete graphics device, coupled to ICH 550, along with other peripheral device(s) 570, such as one or more keyboard, mouse, or numeric keypad.

Alternatively, additional or different processing elements may also be present in the first system 500a. For example, any of the features discussed immediately below in connection with the second system embodiment 500b may be included in the first system 500a. Also, additional processing element(s) 515 may include additional processors(s) that are the same as processor 510, additional processor(s) that are heterogeneous or asymmetric to processor 510, accelerators (such as, e.g., graphics accelerators or digital signal processing (DSP) units), field programmable gate arrays, or any other processing element. There can be a variety of differences between the physical resources 510, 515 in terms of a spectrum of metrics of merit including architectural, microarchitectural, thermal, power consumption characteristics, and the like. These differences may effectively manifest themselves as asymmetry and heterogeneity amongst the processing elements 510, 515. For at least one embodiment, the various processing elements 510, 515 may reside in the same die package.

FIG. 5 also illustrates that the second system 500b may include one or more processing elements 511. As with the first system 500a illustrated in FIG. 5, system 500b is an electronic device that may be implemented using any suitable hardware and/or software to configure electronic device 500b as desired. FIG. 5 illustrates, for one embodiment, an example system 500b includes a touch-sensitive display device 502, one or more processors 511, system control logic 504 coupled to at least one processor 511, system memory 530 coupled to system control logic 504, non-volatile memory and/or storage device(s) 535 coupled to system control logic 504, and one or more communications interfaces 506 coupled to system control logic 504.

Touch-sensitive display device 502 (also referred to herein as a “touchscreen”) may be implemented using any suitable touch-sensitive technology such as, for example and without limitation, capacitive, resistive, surface acoustic wave (SAW), infrared, and optical imaging. The touch-sensitive technology used for touch-sensitive display device 502 for one embodiment may not require actual touching over its surface, but rather may sense the presence of an object near the surface. Such technology may nevertheless be considered touch-sensitive because such technology will similarly sense an object that actually touches over the surface of the display device 502 and because such surface is likely to be actually touched when electronic device 500b is used. Touch-sensitive display device 502 for one embodiment may be implemented using any suitable multi-touch technology. Touch-sensitive display device 502 includes a display that may be implemented using any suitable display technology, such as that for a liquid crystal display (LCD) for example. System control logic 430 for at least one embodiment may include one or more graphics controllers to provide one or more display interfaces to touch-sensitive display device 502.

System control logic 504 for at least one embodiment may include any suitable interface controllers to provide for any suitable interface to at least one processor 511 and/or to any suitable device or component in communication with system control logic 504.

System control logic 504 for at least one embodiment may include one or more memory controllers to provide an interface to system memory 530. System memory 530 may be used to load and store data and/or instructions, for example, for system 500b. For at least one embodiment, system memory 530 may be used to store any suitable software 532, such as any suitable driver software, application software, and/or operating system software (see, e.g., operating system 360 of FIG. 3). System memory 530 for one embodiment may include any suitable volatile memory, such as suitable dynamic random access memory (DRAM) for example.

System control logic 504 for at least one embodiment may include one or more input/output (I/O) controllers to provide an interface to touch-sensitive display device 502, non-volatile memory and/or storage device(s) 535, and communications interface(s) 506.

Non-volatile memory and/or storage device(s) 535 may be used to store data and/or instructions, for example. Non-volatile memory and/or storage device(s) 535 may include any suitable non-volatile memory, such as flash memory for example, and/or may include any suitable non-volatile storage device(s), such as one or more hard disk drives (HDDs), one or more compact disc (CD) drives, and/or one or more digital versatile disc (DVD) drives for example. Non-volatile memory and/or storage device(s) 535 may include, for at least one embodiment, non-volatile Read-Only Memory (ROM) that stores instructions 537 for BIOS processing (see, e.g., BIOS 350 of FIG. 3).

Communications interface(s) 506 may provide an interface for system 500b to communicate over one or more networks and/or with any other suitable device. Communications interface(s) 506 may include any suitable hardware and/or firmware. Communications interface(s) 506 for one embodiment may include, for example, a network adapter, a wireless network adapter, a telephone modem, and/or a wireless modem. For wireless communications, communications interface(s) 506 for one embodiment may use one or more antennas 508.

System control logic 504 for at least one embodiment may include one or more input/output (I/O) controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one embodiment, at least one processor 511 may be packaged together with logic for one or more controllers of system control logic 504. For one embodiment, at least one processor 511 may be packaged together with logic for one or more controllers of system control logic 504 to form a System in Package (SiP). For one embodiment, at least one processor 511 may be integrated on the same die with logic for one or more controllers of system control logic 504. For one embodiment, at least one processor 511 may be integrated on the same die with logic for one or more controllers of system control logic 504 to form a System on Chip (SoC).

Although described for one embodiment as being used in system 500b, touch touch-sensitive display device 502 for other embodiments may be used in other system configurations.

Referring now to FIG. 6, shown is a block diagram of a third system embodiment 600 in accordance with an embodiment of the present invention. As shown in FIG. 6, multiprocessor system 600 is a point-to-point interconnect system, and includes a first processing element 670 and a second processing element 680 coupled via a point-to-point interconnect 650. As shown in FIG. 6, each of processing elements 670 and 680 may be multicore processors, including first and second processor cores (i.e., processor cores 674a and 674b and processor cores 684a and 684b).

Alternatively, one or more of processing elements 670, 680 may be an element other than a processor, such as an accelerator or a field programmable gate array.

While shown with only two processing elements 670, 680, it is to be understood that the scope of the appended claims is not so limited. In other embodiments, one or more additional processing elements may be present in a given processor.

First processing element 670 may further include a memory controller hub (MCH) 672 and point-to-point (P-P) interfaces 676 and 678. Similarly, second processing element 680 may include a MCH 682 and P-P interfaces 686 and 688. As shown in FIG. 6, MCH's 672 and 682 couple the processors to respective memories, namely a memory 632 and a memory 634, which may be portions of main memory locally attached to the respective processors.

First processing element 670 and second processing element 680 may be coupled to a chipset 690 via P-P interconnects 652 and 654, respectively. As shown in FIG. 6, chipset 690 includes P-P interfaces 694 and 698. Furthermore, chipset 690 includes an interface 692 to couple chipset 690 with a high performance graphics engine 638. In one embodiment, bus 639 may be used to couple graphics engine 638 to chipset 690. Alternately, a point-to-point interconnect 639 may couple these components.

In turn, chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the appended claims are not so limited.

As shown in FIG. 6, various I/O devices 614 may be coupled to first bus 616, along with a bus bridge 618 which couples first bus 616 to a second bus 620. In one embodiment, second bus 620 may be a low pin count (LPC) bus. Various devices may be coupled to second bus 620 including, for example, a keyboard and/or mouse 622, communication devices 626 and a data storage unit 628 such as a disk drive or other mass storage device which may include code 630, in one embodiment. The code 630 may include instructions for performing embodiments of one or more of the methods described above. Further, an audio I/O 624 may be coupled to second bus 620. Note that other architectures are possible. For example, instead of the point-to-point architecture of FIG. 6, a system may implement a multi-drop bus or another such architecture.

Referring now to FIG. 7, shown is a block diagram of a fourth system embodiment 700 in accordance with an embodiment of the present invention. Like elements in FIGS. 6 and 7 bear like reference numerals and certain aspects of FIG. 6 have been omitted from FIG. 7 in order to avoid obscuring other aspects of FIG. 7.

FIG. 7 illustrates that the processing elements 670, 680 may include integrated memory and I/O control logic (“CL”) 672 and 682, respectively. For at least one embodiment, the CL 672, 682 may include memory controller hub logic (MCH) such as that described above in connection with FIGS. 5 and 6. In addition. CL 672, 682 may also include I/O control logic. FIG. 7 illustrates that not only are the memories 632, 634 coupled to the CL 672, 682, but also that I/O devices 714 may also be coupled to the control logic 672, 682. Legacy I/O devices 715 may be coupled to the chipset 690.

Embodiments of the mechanisms disclosed herein may be implemented in hardware, software, firmware, or a combination of such implementation approaches. Embodiments may be implemented as computer programs executing on programmable systems comprising at least one processor, a data storage system (including volatile and/or non-volatile memory and/or storage elements), at least one input device, and at least one output device.

Program code, such as code 630 illustrated in FIG. 6, may be applied to input data to perform the functions described herein and generate output information. For example, program code 630 may include an operating system that is coded to perform embodiments of the method 230 illustrated in FIG. 2. Accordingly, embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for enhanced system boot processing that is faster to launch the OS because it does not interrogate I/O devices for possible interruption, but that also may be modified to interrogate such devices based on a user selection mechanism. While particular embodiments of the present invention have been shown and described, it will be obvious to those skilled in the art that numerous changes, variations and modifications can be made without departing from the scope of the appended claims.

Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A computer program product, comprising a computer usable medium having a computer readable program code embodied therein, said computer readable program code adapted to be executed to implement a method, said method comprising:
in a computing device, performing an initial boot sequence, wherein said boot sequence is not user-interruptable;
receiving a user override input to indicate that the next boot sequence should be user-interruptable; and
performing a subsequent boot sequence wherein one or more input devices of the computing device are monitored for user-initiated input.

2. The method of claim 1, further comprising:
receiving said user override input from one of said input devices; and
responsive to said user override input, interrupting the re-boot process to display a user interface.

3. The method of claim 1, wherein performing the initial boot sequence further comprises:
launching an operating system without enumerating the input devices to determine their presence in the computing device.

4. The method of claim 1, wherein performing the initial boot sequence further comprises:
launching an operating system without interrogating the input devices for input data.

5. The method of claim 2, wherein receiving said user override input further comprises:
detecting an expected value in a mailbox storage element.

6. The method of claim 5, wherein said expected value has been provided by a software module.

7. The method of claim 6, wherein said software module is a control panel applet.

8. The method of claim 6, wherein said software module is a software driver.

9. The method of claim 1, wherein receiving said user override input further comprises:
receiving, while the computing device is powered off, a power-on indicator from a hardware indicator that has been depressed by the user for longer than a predetermined amount of time.

10. The method of claim 9, wherein the predetermined amount of time is four seconds.

11. The method of claim 9, wherein said hardware indicator is a power button of said computing device.

12. A system comprising:
a processor;
one or more input devices coupled to the processor;
a non-volatile memory coupled to the processor, the non-volatile memory having stored thereon a plurality of instructions that, when executed by the processor, cause the processor to perform basic input-output processing that launches an operating system;
a system memory coupled to the processor, the system memory having stored thereon said operating system; and
a power button coupled to said processor;
wherein said instructions for said basic input-output processing when executed by the processor, cause the processor, to:
perform an initial boot sequence, wherein said boot sequence is to proceed to launch of an operating system without intervention by a user of said system;
receive a user input to indicate that a subsequent boot process is to be capable of being interrupted by the user; and
perform the subsequent re-boot of the computing device such that said subsequent re-boot includes interrogating the one or more input devices.

13. The system of claim 12, wherein the one or more input devices includes a keyboard.

14. The system of claim 12, wherein the one or more input devices includes a numeric keypad.

15. The system of claim 12, wherein the one or more input devices includes a touchscreen.

16. The system of claim 12, wherein the one or more input devices includes a mouse.

17. An article of manufacture comprising a machine accessible non-transitory storage medium including sequences of instructions, the sequences of instructions including instructions which when executed cause the machine to:
begin to perform a boot process;
determine the value of an interruption indicator; and
responsive to a first value in the interruption indicator, continue the boot process without interrogating one or more input devices for an interruption input;
otherwise, interrogate the one or more input devices for the interruption input.

18. The article of claim 17, further comprising instructions that when executed cause the system to
interrupt the boot process to display a user interface.

19. The article of claim 17, further comprising instructions that when executed cause the system to
cause an operating system to begin execution.

20. The article of claim 17, wherein said value of said interruption indicator is provided via a software mechanism.

21. The article of claim 21, wherein said value of said interruption indicator is provided via a hardware mechanism.
